(19) United States
(12) Patent Application Publication
(10) Pub. No.: US 2002/0069238 A1
(43) Pub. Date: Jun. 6, 2002

(54) Technique to transfer data over a network

(76) Inventors: Douglas F. Eard, Orem, UT (US); Patrick S. Morrow, Orem, UT (US)

Correspondence Address: ANTONELLI, TERRY, STOUT & KRAUS , LLP, Suite 1800, 1300 North Seventeenth Street, Arlington, VA, 22209, US

(21) Appl. No.: 09/729,187

(22) Filed: Dec. 5, 2000

(51) Int. Cl. G06F 15/16; G06F 15/173

(52) U.S. Cl. 709/202; 709/240; 709/223

(57) ABSTRACT

Briefly, embodiments of a technique to transfer data across a network are disclosed.

### FIELD

The invention generally relates to computers and computer networks and in particular to transferring data over a network.

### BACKGROUND

In a traditional data transfer model used for transferring data in a network, a software application may issue a request for a resource, such as to read or write to that resource. A resource may be any information, and is typically stored at a server, computer or other processing node. Issuing a request for a resource in a traditional data transfer model is typically limited to a point-to-point connection. In some cases, this may be extended across a network through the use of proxy servers. A proxy server accepts the request and then acts on the requester's behalf to forward the request to the destination server. The request may be passed through one or more network proxy servers until that request reaches its destination. However, the application usually keeps track of and specifies the specific resource identifier (including specific location or address) for the resource as well as the protocol to be used for sending that request. For example, to receive a stock quote, the client must store the specific name or location or address of the resource where the stock quote can be obtained, such as “finance.yahoo.com/quote,” where yahoo.com may be considered the domain, finance is the specific node within the domain and quote identifies the resource on that node to be accessed. The client may also need to issue the request for the resource using a specific protocol, such as File Transfer Protocol (FTP), Request For Comments 959, October, 1985 or Hypertext Transfer Protocol (HTTP)—HTTP/1.1, Request For Comments 2616, June 1999. The specific address or location of the resource and the protocol are commonly specified together as a Universal Resource Locator (URL). Unfortunately, nodes and resources can be reconfigured or moved, resulting in the specific resource information or URL maintained by the application becoming inaccurate or outdated. An improved technique is desirable.

### BRIEF DESCRIPTION OF THE DRAWINGS

FIG. 1 is a block diagram illustrating an abstract data transfer technique according to an example embodiment.

FIG. 2 is a block diagram illustrating a network according to an example embodiment.

FIG. 3 is a flow chart illustrating an operation of an abstract data transfer according to an example embodiment.

### DETAILED DESCRIPTION

Abstract Data Transfer Technique

As noted above, networks, which are typically one or more switches coupled together via communication links, currently allow network proxy servers to forward requests. However, applications are required to maintain or store the specific location of the resource it would like to access as well as know the specific protocol it must use to access that resource. This may, at times, be a cumbersome and inflexible technique that creates overhead on the application. Also, such an approach may not easily account for the dynamic nature of computer networks, such as the Internet, for example, where nodes and resources can be moved or re-allocated, re-organized, etc.

According to an example embodiment, the specific address or location of a resource is hidden or abstracted from an application. Abstraction refers to the use of a general form rather than a more specific form. In this context, the specific address or location of a resource and a protocol to access the resource are abstracted or hidden from an application. According to an abstract data transfer technique described hereinbelow, an application may refer to or identify a resource using a general resource identifier, and need not specifically identify the particular details of the resource's address, location or access protocol to access that resource. A general resource identifier generally identifies a resource, but typically does not provide all the details of the resource's location or address, or may not specify the protocol to access the resource.

According to an example embodiment, an abstract data transfer (ADT) technique is provided where a plurality of nodes are provided in a network, where each node includes an abstract data transfer (ADT) agent to abstract or hide a resource's specific location and the protocol required to access the resource. The ADT agents at the nodes can dynamically determine the specific location or address of a requested resource and a protocol for accessing the resource based on a general resource identifier provided by the application. The only information an application must maintain or store is a general resource identifier for the resource.

This ADT technique has advantages over the state of the art approach because the abstract data transfer (ADT) technique allows the network infrastructure, including the ADT agents at various processing nodes in the network, to dynamically determine the resource's specific location/address and required access protocol, and also allows the ADT agents to implement a desired quality of service (QOS), which refers to some specified performance for the forwarding of data or packets. This ADT technique also relieves the applications from maintaining the specific locations, addresses or access protocols for each resource to be accessed.

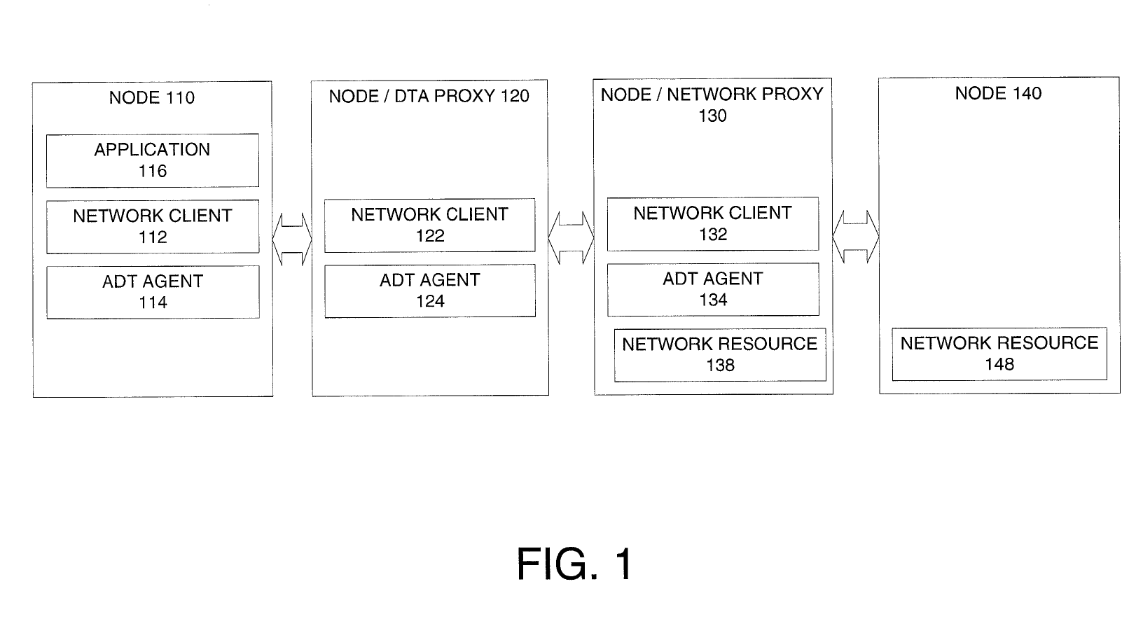

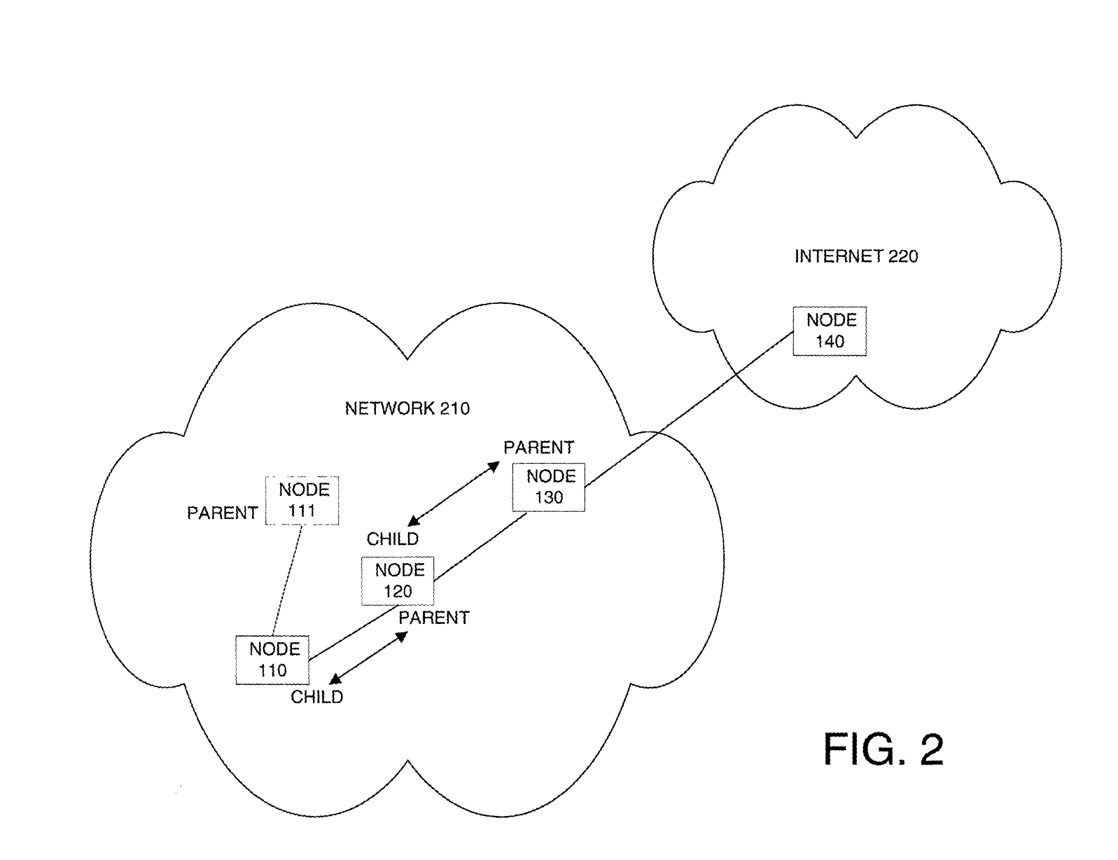

Referring to the Figures wherein like numerals indicate like elements, FIG. 2 is a block diagram illustrating a network according to an example embodiment. FIG. 1 is a block diagram illustrating an example abstract data transfer technique according to an example embodiment. FIG. 1 illustrates additional details of the network of FIG. 2.

Referring to FIG. 2, a network 210 includes a plurality of processing nodes that are connected together, including nodes 110, 120, 130 and 111. A second network, Internet 220, includes processing node 140, and is coupled to network 210. Each processing node (node) may each be a computer, a server or any other processing node, and each typically includes a processor, memory and software. Network 210 may be an Intranet or other network.

Referring to FIGS. 1 and 2, an ADT agent may be installed on or included in each node in the network 210. The ADT agents at the nodes can dynamically determine the specific location or address of a requested resource and a protocol for accessing the resource based on a general resource identifier provided by the application. The ADT agents within network 210 allow for the application 116 to access a network resource based at least in part on a general resource identifier, while abstracting or hiding from application 116 the specific location or address of the resource and/or the protocol to access the resource.

As shown in FIG. 1, node 110 includes a software application (application) 116 which may request access a network resource. Node 110 also includes a network client 112 which is a network communications facility for communicating over a network. The network client 112 may be a separate software program and is used by the application 116 for communicating with other nodes or to issue requests over the network. Node 110 also includes an ADT agent 114 that can either access the requested resource (if located on that node) or will act as a proxy to forward the request to the next ADT agent (i.e., the next node that includes an ADT agent) for application 116.

Node 120 (FIG. 1) includes a network client 122 and an ADT agent 124. Node 130 includes a network client 132, an ADT agent 134 and a network resource 138. Node 140 includes a network resource 148, for this example. According to an example embodiment illustrated in FIG. 1, application 116 of node 110 may issue a request to access either network resource 138 (at node 130) or network resource 148 (at node 140). The ADT agents at each node in the network 210 (FIGS. 1, 2) facilitate the abstraction of the specific location or address of the resource and/or a specific protocol to access the network resource from the application 116.

According to the example embodiment illustrated in FIGS. 1-2, the ADT agents at the nodes may dynamically determine the location of a requested resource and a protocol for accessing the resource based on a general resource identifier provided by the application 116. According to this embodiment, an application can specify or identify a requested network resource using a general resource identifier. A general resource identifier identifies the resource generally, but may not necessarily identify the resource's specific location or address or identify the protocol to access the resource. But rather, by using the general resource identifier, the specific address or location of the resource and a specific protocol for accessing the resource can be abstracted or hidden from the application.

For example, a general resource identifier may be something like “stock quote” to request a specific stock quote or “time of day,” to request the time of day, or “Internet Whitepaper,” (to request a specific whitepaper) or “RFC XXXX,” (to request a specific Internet Request for Comment or RFC) or “turn off my house lights” (to cause a command to be routed to the user's home to turn off the lights), etc. For example, the general identifier “stock quote” may be issued by the application. The ADT agents may then dynamically determine that the general resource identifier “stock quote” issued by the application corresponds to the specific address or location of “www;yahoo.com\mystockquotes,” for example.

Referring to FIG. 2, there is one ADT agent on each node in network 210. According to this particular example embodiment, the ADT agents are hierarchically arranged. That is, the ADT agents have a hierarchical arrangement. In the embodiment shown in FIG. 2, there is a parent-child relationship between some ADT agents. For example, node 110 is the lowest node in the hierarchy and is a child, while node 120 is the parent to node 110, although the invention is not limited in scope in this respect. Similarly, node 130 is a parent to node 120, while node 120 is a child to node 130. In this hierarchical arrangement, ADT agent 114 of node 110 is the lowest rung in the hierarchy in this particular embodiment. ADT agent 124 of node 120 is the next rung or hop in the hierarchy. And, ADT agent 134 of node 130 is at the top rung or hop of the hierarchy. Only three ADT agents/nodes are shown in FIG. 2. Any number of nodes with ADT agents, however, may be used in the network or domain.

Also, this vertical or parent-child hierarchy shown in FIG. 2 is just one simple example that illustrates a possible hierarchical arrangement of ADT agents. Other arrangements may be used as well. For example, there could also be peer-to-peer relationships, multiple parents or multiple children for some nodes, etc. For example, as shown in FIG. 2 in dashed lines, node 110 could have a second parent, shown as node 111.

There are a number of different ways in which the ADT agents may dynamically determine the resource's specific location or address within the scope of the present invention. According to this example embodiment, the first ADT agent 114 receives the request for the resource from the application 116 (FIG. 1), including a general resource identifier. ADT agent 114 determines if it can service the request, for example, it determines if the network resource is available on the node 110. In this case the network resource is not provided on node 110. Therefore, ADT agent 114 forwards the request to the next ADT agent in the hierarchy. In the example shown in FIG. 2, ADT agent 114 of node 1110 would simply forward the request (including the general resource identifier) to its parent ADT agent (i.e., ADT agent 124 of node 120).

This process continues until one of the nodes within the network 210 (or domain) is able to service or process the request. In other words, the request for the resource is forwarded from ADT agent to ADT agent (along or up the hierarchy of agents) until the request reaches the node that provides or includes the requested resource.

In the example shown in FIG. 2, assume that network resource 138 is the requested resource. According to this example embodiment, upon receiving the request and the general resource identifier, the ADT agent 134 would compare the general resource identifier to a list of resources provided (or available) on that node 130. In this case, a match would be found between the general resource identifier and the list of resources because the network resource 138 is provided on node 130. The ADT agent 134 in this embodiment then forwards the request to the requested network resource 138 for servicing, e.g., in this embodiment information is written to resource 138 or obtained from resource 138. If information is read from the network resource, this information is then forwarded back through the ADT agents to the application 116 that requested access to the resource. In the event that information from application 116 is written or stored to the network resource, a reply can be sent back to the application 116 confirming that the requested operation was performed.

In an alternative embodiment, the requested network resource may be located outside the domain of the ADT agents, such as outside of network 210. For example, application 116 may request network resource 148 of node 140. Node 140 is located external to network 210, such as located within network or Internet 220. Node 140 does not include an ADT agent. Therefore, if application 116 would like to access external resource 148 at node 140, the last ADT agent in the domain or network 210, in this example, ADT agent 134 at node 130 within network 210 that is coupled to the adjacent network 220, would receive the request from the previous ADT agent 124, and then compare the general resource identifier against a list to determine if it can service the request. In this case, the general resource identifier identifies network resource 148, which is not available on node 130. Therefore, the ADT agent 134 of node 130 then forwards the request to node 140 using an appropriate protocol or a protocol that is compatible to both networks 210 and 220 or compatible to both nodes 130 and 140. For example, in some embodiments, the ADT agent may issue a HTTP Get message to node 140 in order to access the network resource 148.

The general resource identifier may only be recognized or understood by the ADT agents within network 210. Therefore, if the application has requested a network resource outside the network or domain of ADT agents, a technique should be provided to map or translate the general resource identifier to a specific resource identifier for the requested resource, such as to a specific address or location and/or protocol, such as a URL that points to the requested resource. The last ADT agent 130 in the network 210 may access a look-up table or map to determine the resource's specific location or address and/or the protocol that should be used to access the resource based on the general resource identifier. The look-up table or map may either be locally stored by the ADT agent or stored on a remote server which can be accessed by the ADT agent through one or more networks. For instance, node 130 may be one of few nodes, or even the only node, within network 210 with access to network 220, or with access to the general resource identifier—to—specific resource identifier map.

Alternatively, if the Application 116 knows the resource is located outside network 210 and already knows the specific resource identifier for the resource, the application 116 may actually provide the specific resource identifier, such as the protocol and specific address/location or URL for the requested resource along with the request. In such case, any one of the ADT agents or nodes that has access to Internet 220 and can issue the request using the required protocol could then issue the request to node 140, in the event that the application has requested access to external resource 148.

Quality Of Service

In addition, the ADT agents can enforce a quality of service (QOS). As used herein, quality of service (QOS) may be any specified performance attribute related to the forwarding of data or packets. There are many types of QOS. Some examples of QOS include a packet priority where an ADT agent forwards higher priority packets before lower priority packets, bandwidth throttling that limits use of a network to a maximum specified percentage of bandwidth for example, or a window of opportunity where certain packets are forwarded only during specific times of day, such as at night when the network is not as busy, a specific data throughput as either bits per second or packets per second, etc.

According to an example embodiment, there are two types of QOS, including a path QOS and a per-link QOS. A path QOS is specified by an application that makes a request for a resource, such as application 116, and is enforced by each ADT agent along the path. The path QOS is specified or defined in the packet that is being forwarded. In this manner, each ADT agent along the forwarding path enforces the path QOS, which means that the ADT agent forwards packets according to that path QOS defined in the packet.

According to an example embodiment, a per-link QOS is defined by a configuration of a sending ADT agent, and specifies a QOS to be enforced over a link connected to the ADT agent. Thus, each ADT agent may include one or more per-link QOSs defined by the ADT agent's configuration.

Each ADT agent typically enforces both the path QOS, specified by the requesting application, and the per-link QOS, specified by the configuration of the sending ADT agent. For example, the path QOS may require the packet be forwarded using less than 5% of the bandwidth, whereas the per-link QOS may require the packets be forwarded over the link between 2 am and 4 am. Thus, the ADT agent enforces both the path QOS and the per-link QOS.

According to another embodiment, in the event the path QOS and the per-link QOS relate to the same type of QOS parameter, the ADT agent would typically enforce the more stringent QOS. For example, if the path QOS requires the packet be forwarded using less than 5% of the bandwidth and the per-link QOS requires that the packets be forwarded over a particularly low bandwidth link using less than 1% of the link's bandwidth, then the ADT agent would enforce the 1% QOS because that requirement is more stringent than 5% and meets both QOSs.

An agent that receives a packet including a request in the packet for a required QOS is typically required to fulfill that required path QOS. According to one embodiment, if an ADT receives a request from another ADT agent to forward data according to a required path QOS as specified in the packet, in the event the receiving ADT agent cannot fulfill the required path QOS, the receiving ADT agent will typically inform the requesting ADT agent that it cannot fulfill the required path QOS, and the requesting ADT agent will search for an alternative path or may notify the original requesting application that the required path QOS cannot be fulfilled.

Of course, for external resources, once the request is forwarded outside the domain of the ADT agents, such as to the Internet 220, the last ADT agent or ADT agent coupled to both networks, can request the original path QOS, although the path QOS may or may not be fulfilled by nodes in the external network, Internet 220.

If the request is to write or store information to the network resource, then packets may be sent via the hierarchical path along the ADT agents to the network resource. If the request is to read or obtain information from the resource, such as to obtain a stock quote, or to obtain streaming video, etc., the request may sent along the path of hierarchical ADT agents, and the requested data is returned, for example along the same path. According to another embodiment, the path QOS may be implemented may be enforced for both the request along a forward path through the hierarchically arranged ADT agents and for the response along a return path through the hierarchically arranged ADT agents.

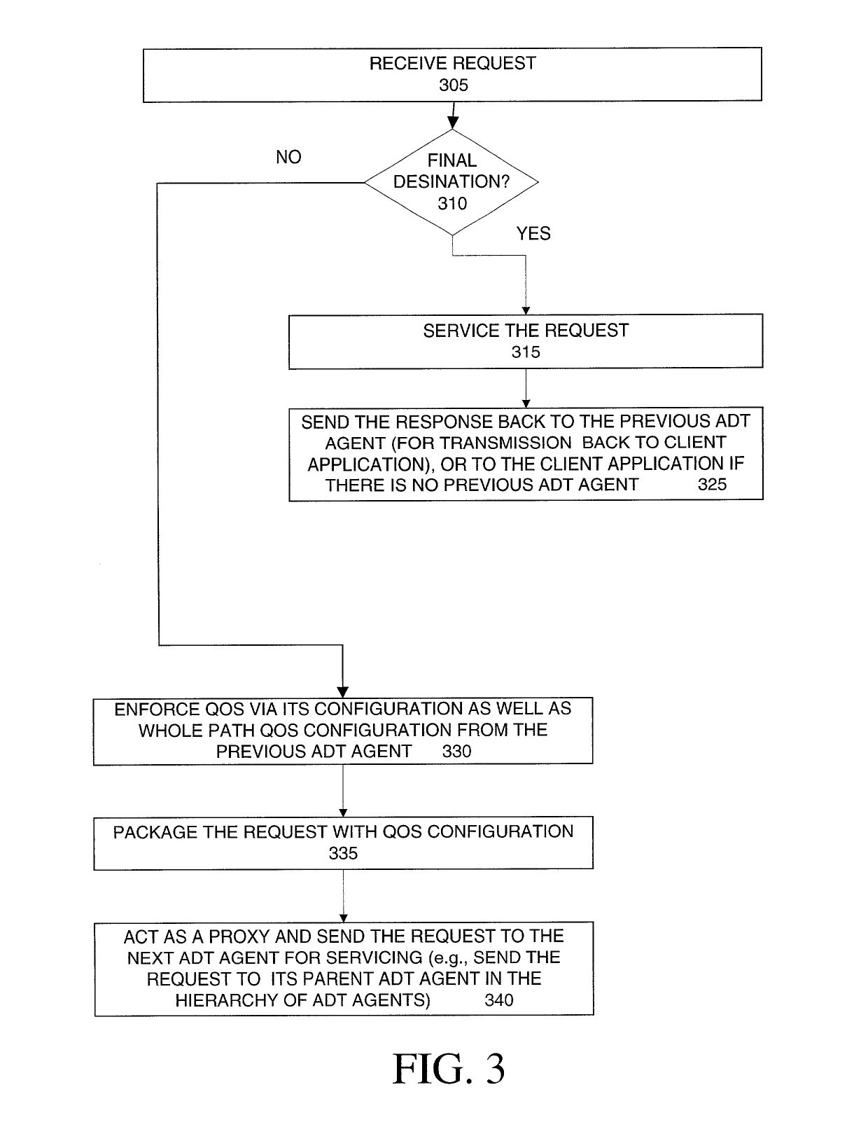

FIG. 3 is a flow chart illustrating an example operation of an abstract data transfer technique according to an example embodiment. At block 305, the request for access to a resource is received by the ADT agent. At block 310, the ADT agent determines whether it is the final destination for the request, which means it determines whether it can service the request.

Blocks 315 and 325 are performed if the ADT agent is the final destination, meaning that the requested resource is available on the node and further hops in the forward direction are unnecessary. In such case, the request is serviced by the locally available network resource, block 315.

At block 325, the ADT agent sends the response or requested information back to the previous ADT agent for transmission back to the requesting application if there are previous agents in the return path to the application. In the event that there is no previous ADT agent in the return path to the application, meaning that this node includes the application, then the ADT agent provides the response to the resident application.

Blocks 330, 335 and 340 are performed by the ADT agent if the ADT agent is not the final destination, such as if the request cannot be serviced on the node or the requested service is not locally available on the node. At block 330, the ADT agent enforces a per-link QOS based on its configuration as well as the whole path QOS specified by a path QOS identifier provided in the packet. The per-link QOS and path QOS are enforced by the ADT agent over the link to the next ADT agent in the hierarchy, such as to the ADT agent's parent. The request, the general resource identifier and the path QOS identifier are then packaged, block 335. The ADT agent then acts as a proxy to then send or forward the request, the general resource identifier, and the path QOS identifier to the next ADT agent (e.g., to its hierarchical parent) for servicing, block 340. The request is forwarded while enforcing the path QOS and per-link QOS.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
sending a request for a network resource from an application to a first agent, the request including a general resource identifier generally identifying the requested resource to agents within a domain and a path QOS identifier specifying a path quality of service;
forwarding the request from the first agent to a second agent while enforcing the path quality of service specified by the path QOS identifier.

2. The method of claim 1 wherein the forwarding comprises enforcing a per-link quality of service between the first and second agents.

3. The method of claim 1 wherein quality of service comprises a specified performance for the forwarding of data or packets.

4. The method of claim 1 wherein the agents within the domain resolve the general resource identifier to a specific identifier by forwarding the request to another agent in the domain until the request reaches a destination where the request can be fulfilled.

5. The method of claim 1 and further comprising the second agent forwarding the request to a third agent, while enforcing the path quality of service specified by the path QOS identifier, the third agent coupled to the requested network resource.

6. The method of claim 5 and further comprising the third agent fulfilling the request based on the general resource identifier.

7. A method of resolving a general resource identifier in a network of agents comprising:
receiving a request for a network resource at a first agent, the request including a general resource identifier generally identifying the requested resource to agents within a network;
repeatedly forwarding the request to a next agent in the network of agents until the request is received by an agent that is coupled to the requested resource.

8. The method of claim 7 wherein the request also includes a path QOS identifier identifying a QOS to be enforced, and wherein repeatedly forwarding comprises repeatedly forwarding the request to a next agent while enforcing the QOS identified by the QOS identifier.

9. The method of claim 7 wherein the network of agents comprises a network of hierarchically arranged agents, and repeatedly forwarding comprises repeatedly forwarding the request to a next agent in the network of hierarchically arranged agents while enforcing the path QOS identified by the QOS identifier.

10. The method of claim 7 and further comprising each agent enforcing a per-link QOS in addition to the path QOS when forwarding the request to a next agent.

11. A method comprising:
sending a request for a network resource from an application to a first agent, the request including a general resource identifier generally identifying the requested resource to agents within a domain;
sending the request from the first agent to a second agent;
fulfilling the request at the second agent if the requested resource is available to the second agent;
forwarding the request from the second agent to a next agent if the requested resource is not available to the second agent; and
enforcing a path quality of service across the agents.

12. The method of claim 11 wherein the first and second agents are part of a group of agents within a domain or network.

13. The method of claim 12 wherein the agents are hierarchically arranged.

14. The method of claim 13 wherein at least some of the hierarchically arranged agents have parent-child relationships.

15. The method of claim 14 wherein the hierarchically arranged agents allows the application to request the resource using the general resource identifier, while abstracting a specific address or location of the resource from the application.

16. The method of claim 11 and further comprising comparing the general resource identifier to a list of resources available to the first agent.

17. The method of claim 11 and further comprising:
returning a response or requested information from the requested resource to the application via a return path along the second and first agents respectively, the quality of service also being enforced along the return path.

18. An article comprising a computer readable media having instructions stored thereon, the instructions resulting in the following when executed by a machine:
sending a request for a network resource from an application to a first agent, the request including a general resource identifier generally identifying the requested resource to agents within a domain;
sending the request from the first agent to a second agent;
servicing the request at the second agent if the requested resource is available to the second agent;
forwarding the request from the second agent to a next agent if the requested resource is not available to the second agent; and
enforcing a quality of service across the agents.

19. The article of claim 18, wherein the agents are hierarchically arranged, wherein the hierarchically arranged agents allow the application to request the resource using the general resource identifier, while abstracting a specific address or location of the resource from the application.

20. An article comprising a computer readable media having instructions stored thereon, the instructions resulting in the following when executed by a machine:
sending a request for a network resource from an application to a first agent, the request including a general resource identifier generally identifying the requested resource to agents within a domain and a path QOS identifier specifying a path quality of service; and
forwarding the request from the first agent to a second agent while enforcing the path quality of service specified by the path QOS identifier.

21. The article of claim 20 wherein forwarding further comprises enforcing a per-link QOS.

22. A first node coupled to other nodes in a domain, the first node comprising
a network client to provide communications with other nodes in the domain; and
an agent to abstract the specific location or address of one or more network resources from one or more applications within the domain, the agent to receive a request for a resource along with a general resource identifier and to service the request if the requested resource is locally available and otherwise to forward the request to a next agent in the domain if the resource is not available to the agent, the agent to enforce a quality of service with one or more other agents in the domain.

23. The first node of claim 22 wherein one agent is provided on each node within the domain.

24. An apparatus comprising:
a network comprising a plurality of hierarchically agents coupled to each other, an application coupled to a first of the agents to make a request for a resource based on a general resource identifier;
each of the agents to forward the request to a next agent of the hierarchically arranged agents until the request is received by an agent coupled to the requested resource.

25. The apparatus of claim 24 wherein each agent is provided to forward a received request according to a path QOS specified by the application.

26. A method comprising:
sending a request for a network resource from an application to a first agent, the request including a general resource identifier generally identifying the requested resource to agents within a domain; and
forwarding the request from the first agent to a second agent, the second agent fulfilling the request based on the general resource identifier.
